(19) United States
(12) Patent Application Publication
(10) Pub. No.: US 2021/0394692 A1
(43) Pub. Date: Dec. 23, 2021

(54) SOUND PROTECTION PANEL FOR A MOTOR VEHICLE ENGINE COMPARTMENT

(71) Applicant: TREVES PRODUCTS, SERVICES & INNOVATION, Paris (FR)

(72) Inventors: Arnaud Duval, Paris (FR); Eric Brillon, Rosnay (FR); Laurence Lucchese, Paris (FR)

(21) Appl. No.: 17/277,792

(22) PCT Filed: Sep. 19, 2019
(86) PCT No.: PCT/EP2019/075258

§ 371 Date: Sep. 8, 2021

(30) Foreign Application Priority Data
Sep. 20, 2018 (FR) 1858538

(51) Int. Cl. B60R 13/08; B29C 44/12; B29C 44/06

(52) U.S. Cl. CPC B60R 13/0838; B29C 44/1285; B29K 2075/00; B29C 44/1209; B29K 2995/0002; B29C 44/065

(57) ABSTRACT

The invention relates to a panel with a porous shell and a spring layer, part of which enters the shell and produces an integrated sealed barrier. The foam of the shell is an integral skinned foam and the shell has a core with a substantially homogenous density and a porous skin. The overall density of the shell is between 150 and 350 kg/m3. The skin thickness is between 0.3 and 2 mm and has a permeability such that a 2 mm thick foam strip cut into the shell and integrating the skin exhibits air flow resistance of between 250 and 2000 N.s.m−3.

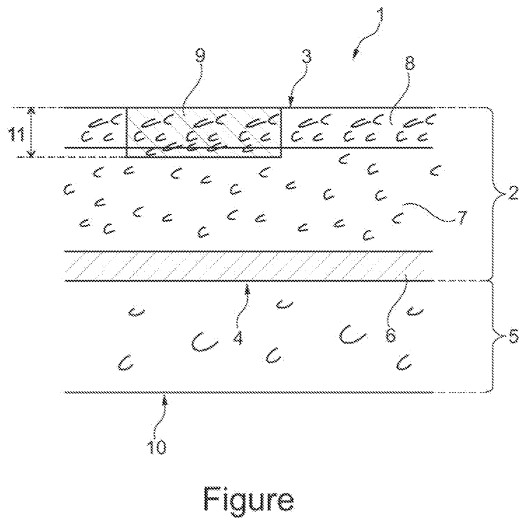

This application claims the benefit of International application number PCT/EP2019/075258, filed Sep. 19, 2019 and French application number 1858538, filed Sep. 20, 2018 the entire contents of which are incorporated herein by reference.

### TECHNICAL FIELD

The invention relates to a sound protection panel for a motor vehicle engine compartment and a method for producing such a panel.

### BACKGROUND

Producing a sound protection panel for a motor vehicle engine compartment is known, for example from the document FR 3 024 675 A1, the panel comprising:
a porous shell having a front face and a back face, the shell being based on polyurethane foam,
a spring layer made from elastically compressible moulded polyurethane foam overmoulding the shell by the back face thereof, part of the foam of the layer entering the shell over a proportion of the thickness thereof the shell is provided on its back face of an integrated sealed barrier,
   the panel provides sound protection:
by insulation, according to a “mass-spring” principle, the mass of which is formed by the shell,
and by absorption through the porosity of the shell.

With such an arrangement, the shell therefore participates in the absorption of the sound waves.

However, it is observed that this absorption is not optimised in the medium-frequency domain, in particular between 500 and 1000 Hz.

When it is wished to optimise the medium-frequency absorption properties of a porous element—in this case the aforementioned shell—its known to clad it with a “resistive layer”, having resistance to the passage of air greater than that of the element in order to obtain a “bi-permeable” effect as described by J. F. Allard in the work “Sound propagation in porous media”, Elsevier, 2^{nd} edition 2009, p. 266-271.

However, adding such a “resistive layer” makes producing the panel more complex and gives rise to an associated extra cost.

### SUMMARY OF THE INVENTION

The aim of the invention is to overcome this drawback.

For this purpose, and according to a first aspect, the invention proposes a sound protection panel for a motor vehicle engine compartment, the panel comprising:
a porous shell having a front face and a back face, the shell being based on polyurethane foam,
a spring layer made from elastically compressible moulded polyurethane foam overmoulding the shell by the back face thereof, part of the foam of the layer entering the shell over a proportion of the thickness thereof so that the shell is provided on its back face with an integrated sealed barrier, the panel provides sound protection:
by insulation, according to a “mass-spring” principle, the mass of which is formed by the shell,
and by absorption through the porosity of the shell,
   the panel furthermore having the following features:
the foam of the shell is an integral skinned foam the shell has:
   a core with substantially homogeneous density,
   and a porous skin corresponding to the proportion of thickness where the density of the foam is greater than that of the core,
the overall denseness of the shell is between 150 and 350 kg/m³, the shell has a mass per unit surface area that is sufficient for fulfilling its role of mass,
the skin has, on the front face, to optimise the absorption of the medium-frequency sound waves:
   a thickness of between 0.3 and 2 mm,
   and a permeability such that a 2 mm thick strip of foam cut into the shell and integrating the skin exhibits air flow resistance of between 250 and 2000 N.s.m⁻³.

It is specified here that the use of the term “density” is a language shorthand signifying “volumetric mass density”; this is why a unit of measurement (kg/m³) is attached thereto.

It is well known that integral skinned polyurethane foams comprise a foam core of moderate density surrounded by a high-density skin of the same chemical nature, the core and the skin being produced in a single moulding operation.

As stated above, the skin corresponds to the proportion of thickness of foam that has a density greater than that of the core, on the understanding that, in reality, this density of skin increases gradually on moving towards the external surface.

The thickness of the skin is dependent in particular on the type of expansion agent used to form the foam, and also on the temperature and pressure conditions used in the mould.

When overall density of the shell is spoken of, the total volume thereof is considered in order to determine it, on the understanding that the shell comprises:
the core mentioned above, provided with constant density,
the skin mentioned above, provided with increasing density on moving towards the external surface thereof,
and a proportion of the thickness thereof penetrated by the foam coming from the spring layer.

With the arrangement proposed, the shell has a core of uniform density that will play a conventional role of sound protection by absorption.

Since the shell is provided with a porous skin resulting from moulding, the role usually devolved to the “resistive layer” known from the prior art will be conferred on the skin provided with suitable permeability, on the front face of the shell.

In this way the addition of a “resistive layer” is dispensed with, the layer being formed by the skin that is integrated in the foam, which simplifies the production of the panel and reduces the manufacturing cost thereof.

It will furthermore be noted that the presence of a skin makes it possible to protect the panel against fluids such as water or oil to which it may be exposed, and to prevent—or at least to limit—the penetration of the fluids in the shell, which could then no longer fulfil its absorption role if it were impregnated therewith.

Finally, having a moulded panel makes it possible to very easily confer thereon a geometry making it possible best to match the shape of the engine element to be protected, and thus to limit acoustic leaks.

According to a second aspect, the invention proposes a method for manufacturing such a panel.

### BRIEF DESCRIPTION OF THE DRAWINGS

Other particularities and advantages of the invention will appear in the following description, made with reference to the accompanying FIGURE, which is a partial schematic view in cross section of a panel according to one embodiment.

### DETAILED DESCRIPTION

With reference to the FIGURE, a sound protection panel 1 for a motor vehicle engine compartment is described, the panel comprising:
a porous shell 2 having a front face 3 and a back face 4, the shell being based on polyurethane foam,
a spring layer 5 made from elastically compressible moulded polyurethane foam overmoulding the shell by back face, part of the foam of the layer entering the shell over a proportion of the thickness thereof the shell is provided on its back face with an integrated sealed barrier 6,
   the panel provides sound protection:
by insulation, according to a “mass-spring” principle, the mass of which is formed by the shell,
and by absorption through the porosity of the shell,
   the panel furthermore having the following features:
the foam of the shell is an integral skinned foam the shell has:
   a core 7 with substantially homogeneous density,
   and a porous skin 8 corresponding to the proportion of thickness where the density of the foam is greater than that of the core,
the overall density of the shell is between 150 and 350 kg/m³, the shell has a mass per unit surface area that is sufficient for fulfilling its role of mass,
the skin has, on the front face, to optimise the absorption of the medium-frequency sound waves:
   a thickness of between 0.3 and 2 mm, namely between 0.4 and 0.7 mm,
   and a permeability such that a 2 mm thick 11 strip 9 of foam cut into the shell—for example by water-jet cutting—and integrating the skin exhibits air flow resistance of between 250 and 2000 N.s.m⁻³.

To facilitate measurement, a strip 9 is preferably taken in a substantially flat region, having for example dimensions 50×50 mm.

According to one embodiment, the shell 2 has a Young's modulus under compression of between 10⁶ and 10⁸ Pa.

In order to make such a measurement, a sample of shell 2 is taken by separating it from the spring layer 5, for example by water-jet cutting.

To facilitate the measurement, the sample is taken in a substantially flat region with a substantially constant thickness.

A shell 2 provided with such a Young's modulus has sufficient stiffness to avoid the appearance of a high-frequency resonance peak.

According to one embodiment, the core 7 of the shell 2 has relatively low a tortuousness—typically less than 1.8—making it possible to avoid, in the presence of the skin 8, saturation of the absorption in medium and high frequencies.

According to one embodiment, the shell 2 has a thickness—which may be variable—of between 3 and 30 mm, and in particular between 7 and 15 mm.

According to one embodiment, the shell 2 has an overall density of between 150 and 250 kg/m³.

With such a thickness combined with such an overall density, the shell 2 has a sufficient mass per unit surface area to make it effective as a mass in a mass-spring system in insulation.

According to one embodiment, the spring layer 5 has a Young's modulus under compression of between 10⁴ and 2.10⁵ Pa.

To make such a measurement, a sample of spring layer 5 is taken by separating it from the shell 2, for example by water-jet cutting.

According to one embodiment, the spring layer 5 has a density of between 40 and 120 kg/m³, and in particular between 70 and 90 kg/m³.

According to an embodiment that is not shown, the foam of the spring layer 5 is also an integral skinned foam, the external face 10 thereof being provided with a porous skin, in the same way as the front face 3 of the shell 2.

It is then possible to observe a phenomenon of sound absorption produced by the spring layer 5 with amplification of the absorption in medium frequencies related to the presence of the skin, as in the case of the shell 2, which can be very effective when the shell follows complex engine shapes.

According to one embodiment, the spring layer 5 has a thickness of between 10 and 40 mm.

In order to produce the shell 2 and the spring layer 5, the water serves as an expansion agent (the proportion of water in the foam precursor mixture of the shell 2 being one of the factors making it possible to adjust the overall density thereof), as well as the mould temperatures and the density obtained after moulding.

Finally, a method for producing such a sound protection panel 1 is described, the method comprising the following steps:
producing an absorbent shell 2, having a front face 3 and a back face 4, by injecting into a mould defining a first moulding cavity a first polyurethane foam precursor mixture, the formulation of said mixture and the physical conditions of the moulding being arranged so that the shell has a core 7 with a substantially homogeneous density and a porous skin 8 formed on the front face by the proportion of thickness of foam of accentuated density,
producing a second moulding cavity—for example by changing the lid of the vmould—wherein the shell is disposed, the back face 4 thereof being turned towards the cavity, the cavity defining a moulding space opposite the face,
overmoulding the back face by a spring layer 5 by injecting into the space a second elastically compressible polyurethane foam precursor mixture, the formulation of the mixture, the physical conditions of the moulding and the porosity of the skin on the back face being arranged so that the foam of the layer enters the shell over a proportion of the thickness thereof to produce a sealed barrier 6.

What is claimed is:

1. A sound protection panel for a motor vehicle engine compartment, the panel comprising:
a porous shell having a front face and a back face, the shell being based on polyurethane foam,
a spring layer made from elastically compressible moulded polyurethane foam overmoulding the porous shell by the back face, part of the foam of the spring layer entering the porous shell over a proportion of the thickness of the porous shell, the porous shell is provided on its back face with an integrated sealed barrier,
the panel provides sound protection
by insulation, according to a “mass-spring” principle, the mass of which is formed by the porous shell,
and by absorption through the porosity of the porous shell,
the panel wherein
the foam of the porous shell is an integral skinned foam the porous shell having
a core with substantially homogeneous density,
and a porous skin corresponding to the proportion of thickness where the density of the foam is greater than that of the core,
the overall density of the shell is between 150 and 350 kg/m³, the shell has a mass per unit surface area that is sufficient for fulfilling its role of a mass,
the skin has, on said front face, to optimise the absorption of the medium-frequency sound waves
a thickness of between 0.3 and 2 mm,
and a permeability such that a 2 mm thick strip of foam cut into the porous shell and integrating the skin exhibits air flow resistance of between 250 and 2000 N.s.m⁻³.

2. The panel according to claim 1, wherein the porous shell has a Young's modulus under compression of between 10⁶ and 10⁸ Pa.

3. The panel according to claim 1, wherein the shell has a thickness of between 3 and 30 mm, and in particular between 7 and 15 mm.

4. The panel according to claim 1, wherein the shell has an overall density of between 150 and 250 kg/m³.

5. The panel according to claim 1, wherein the spring layer has a Young's modulus under compression of between 10⁴ and 2.10⁵ Pa.

6. The panel according to claim 1, wherein the spring layer has a density of between 40 and 120 kg/m³.

7. The method for producing a sound protection panel according to claim 1, the method comprising the following steps:
producing an absorbent shell, having a front face and a back face, by injecting into a mould defining a first moulding cavity a first polyurethane foam precursor mixture, the first precursor mixture and the physical conditions of the moulding being adapted to form a core with a substantially homogeneous density and the porous skin formed on the front face by the proportion of thickness of foam of accentuated density,
producing a second moulding cavity wherein the shell is disposed, the back face being turned towards the cavity, the cavity defining a moulding space opposite the face,
overmoulding the back face by a spring layer by injecting into the space a second elastically compressible polyurethane foam precursor mixture, the formulation of the second precursor mixture, the physical conditions of the moulding and the porosity of the skin on the back face being to allow the foam of the spring layer to enter the shell over a proportion of the thickness to produce a sealed barrier.
